(19) United States
(12) Patent Application Publication
(10) Pub. No.: US 2024/0376909 A1
(43) Pub. Date: Nov. 14, 2024

(54) ACTUATOR DEVICE AND METHOD FOR OPERATING SUCH AN ACTUATOR DEVICE

(71) Applicant: METISMOTION GMBH, Munich (DE)

(72) Inventors: Wolfgang Zöls, Munich (DE); Patrick Fröse, Munich (DE); Christopher McClanahan, Irschenberg (DE); Georg Bachmaier, Munich (DE)

(21) Appl. No.: 18/696,319

(22) PCT Filed: Sep. 29, 2021
(86) PCT No.: PCT/EP2021/076826

§ 371 Date: Mar. 27, 2024

(51) Int. Cl. F15B 7/00

(52) U.S. Cl. CPC F15B 7/00; F15B 2211/20538; F15B 2211/30505; F15B 2211/329

(57) ABSTRACT

The invention relates to an actuator device, having two working chambers which are coupled to one another in such a way that a volume increase in a first of the working chambers is associated with a volume decrease in the second working chamber, and vice versa. There is provided an output device which can be driven, and thus moved, by the respective volume increase in the respective working chamber. There is provided a pump device having a solid-state actuator and intended for conveying a fluid. There is provided a first flow path through which the fluid conveyed by means of the pump device can flow and via which, to bring about the volume increase in the first working chamber, the fluid conveyed by means of the pump device and flowing through the first flow path can be introduced into the first working chamber.

### CROSS-REFERENCE TO RELATED APPLICATIONS

This application is a U.S. national phase application filed under 35 U.S.C. § 371 of International Application Number PCT/EP2021/076826, filed Sep. 29, 2021, designating the United States, which is hereby incorporated herein by reference in its entirety.

### FIELD

The invention relates to an actuator device and a method for operating such an actuator device.

### BACKGROUND

Actuator devices and methods for operating such actuator devices are already well known from the general state of the art and technology standards today. The actuator devices are usually utilized to move and/or clamp and/or deform and/or compress an object. For this purpose, for example, a fluid, especially a liquid in this case, has to be conveyed by means of a pump in order to move at least one drive unit element and thereby to move and/or tension and/or deform and/or compress and/or reshape the object via the drive unit element. In common examples, a transmission element, in particular fluidic and in particular hydraulic, is normally provided between the pump and the drive unit element. The transmission element therefore makes it possible, for example, for an initial force to be applied in order to operate the pump, whereby a second force, which is larger or smaller than the first force subsequently acts on the drive unit element or the drive unit element also provides a second force which is larger or smaller than the initial force in order to move and/or tension and/or deform and/or compress and/or reshape the object. In general terms, a force, in particular the second force, can be exerted on the object by means of the actuator device in order, for example, to move and/or clamp the object i.e. to secure it against movement. The object of the present invention is to provide an actuator device and a method for operating such an actuator device, so that a particularly advantageous operation of the actuator device can be realized.

### SUMMARY

This task is solved by an actuator device with the features of Claim 1 and by a method with the features of Claim 14. Advantageous embodiments with useful further embodiments of the invention are given in the remaining claims.

An initial aspect of the invention relates to an actuator device which has at least two drive unit chambers, which are also referred to as working chambers, and which are coupled to one another in such a way that an increase in volume of a first of the working chambers is accompanied, in particular simultaneously, by a reduction in volume of the second working chamber and vice versa. This therefore means that an increase in the volume of the second working chamber is accompanied by a reduction in the volume of the first working chamber, particularly at the same time. The increase in volume does not necessarily have to correspond to the reduction in volume. In other words, it is thereby conceivable that the reduction in volume is larger or smaller than the increase in volume. In other words, the reduction in volume can be larger or smaller than the increase in volume and vice versa. In particular, it is conceivable that, for example, when a particularly gaseous or liquid and very preferably incompressible medium flows out of the first working chamber, since a reduction in volume of the first working chamber occurs, then the medium or another additional, preferably gaseous or liquid and particularly incompressible medium flows into the second chamber, since the reduction in volume of the first working chamber is accompanied by an increase in volume of the second working chamber. In particular, it is conceivable that a first quantity of the medium flows out of the first working chamber and a second quantity of the medium or a second quantity of the further medium flows into the second working chamber, whereby the first quantity can correspond to the second quantity, or whereby the quantities are different. The media or quantities can also be the same medium or the same medium. The actuator device also has an drive unit device which can be driven by the respective increase in volume of the respective working chamber and can therefore be moved. This is to be understood in particular as meaning that the respective increase in volume of the respective working chamber can cause and/or causes a particularly translatory and/or rotatory and/or oscillating movement of the drive unit device. The drive unit device can, for example, possess a minimum of at least or exactly one drive unit element which, for example, can be moved in a first direction of movement by the increase in volume of the first working chamber and in a second direction of movement, in particular translatory and/or rotatory and/or oscillating, by the increase in volume of the second working chamber, wherein, for example, the second direction of movement is opposite to the first direction of movement. It is also conceivable, for example, that the drive unit device has at least or exactly two drive unit elements. By increasing the volume of the first drive unit chamber, for example, a first of the drive unit elements can be moved in a first element direction, in particular translationally and/or rotationally and/or oscillatingly. By increasing the volume of the second working chamber, for example, a second of the drive unit elements can be moved in a second element direction, in particular translationally and/or rotationally and/or oscillatingly. It is conceivable that the element directions run parallel, at an angle or perpendicular to each other. The element directions can point in the same direction or the element directions can be opposite to each other. In this case, for example, a reduction in the volume of the first working chamber is accompanied by a movement of the first drive unit element in a third element direction, which is, for example, opposite to the first element direction. It is also conceivable that a reduction in the volume of the second working chamber is accompanied by a movement of the second drive unit element in a fourth element direction, which is opposite to the second element direction, for example.

The actuator device also comprises a pumping device for pumping a fluid, which is, for example, the aforementioned medium and in particular the additional medium, whereby the fluid can be a gas. Very preferably, however, the fluid should be a liquid, in particular an incompressible liquid. In other words, the fluid is preferably an incompressible fluid, in particular an incompressible liquid whose density does not depend on the pressure.

Furthermore, the actuator device also possesses an initial flow path through which the fluid conveyed by the pumping device can flow and which is preferably arranged or extends upstream of the first working chamber and downstream of the pumping device in the direction of flow of the fluid to be conveyed by the pumping device and, in particular, flowing through the first flow path. In order to effect the increase in volume of the first working chamber, the fluid conveyed by the pump device and, in particular, that which is flowing through the first flow path can be introduced into the first working chamber via the first flow path. The actuator device also has a second flow path through which the fluid conveyed by the pumping device can flow and which is preferably arranged, or which extends upstream of the second working chamber and downstream of the pumping device in the direction of flow of the fluid conveyed by the pumping device and, in particular, thereby flowing through the second flow path. Utilizing the second flow path, means that the fluid conveyed by means of the pump device and, in particular thereby, flowing through the second flow path can be introduced into the second working chamber. In other words, by means of the respective flow path, which therefore enables the fluid conveyed by means of the pumping device to be guided or directed from the pumping device to and into the respective working chamber. The flow paths can, for example, be at least partially separated from one another, in particular fluidically.

The pump device is equipped with a minimum of one solid-state actuator. In the context of the present disclosure, this one or a solid-state actuator is to be understood, for example, as a Piezo actuator which possesses at least one or more, in particular stacked, Piezo elements and, by applying an electrical voltage to the Piezo actuator, thereby executes a mechanical movement or is deformed, in particular elongated or reduced in size, and therefore executes a movement at least in a partial region. Furthermore, a solid-state actuator is to be understood, for example, as a magnetostrictive actuator which has at least one solid body which can be deformed or is subsequently deformed by the application of a magnetic field i.e. when the solid body is exposed to a magnetic field. Furthermore, an or the solid-state actuator can be understood as an electrostrictive actuator, which in particular has a medium, in particular a dielectric medium, which is formed as a solid body and can be deformed and moved at least in a partial range by applying an electric field to the medium. Furthermore, one unit and/or a solid-state actuator can also be understood to be a solenoid actuator which is hereby simply referred to as a solenoid. The solenoid actuator comprises at least and/or exactly one coil through which an electric current can be passed, whereby a magnetic field can be provided by means of the coil, whereby at least one movement element, which is in particular designed as a solid body and is also referred to as a slider, can be moved, in particular relative to the coil and/or translationally, whereby the coil is also a solid body. The solenoid actuator is also referred to as a linear magnetic actuator. Furthermore, the one unit and/or solid-state actuator can be considered to be a polymer actuator which has at least one electroactive polymer (EAP) which can be deformed by applying an electrical voltage to the electroactive polymer and can therefore be moved at least in a partial range.

The actuator device also possesses one initial discharge path associated with the first working chamber, via which the fluid can be discharged from the first working chamber in order to reduce the volume of the first working chamber. The actuator device also comprises a second discharge path associated with the second working chamber, via which the fluid can be discharged from the second working chamber in order to reduce the volume of the second working chamber.

An initial valve element is arranged in the first discharge path, which can be moved between a first closed position, which closes the first discharge path, and at least one first open position, which opens the first discharge path. In the first open position, the fluid can be or is discharged from the first working chamber, since in the first closed position the initial valve element opens the first discharge path for a flow of the fluid from the first working chamber through the first discharge path. In the first closed position, however, the initial valve element closes the first discharge path, so that in the first closed position the fluid does not flow through the first discharge path and therefore cannot flow out of the first working chamber via the first discharge path.

A second valve element is arranged in the second discharge path, which can be moved between a second closed position, which thereby closes the second discharge path, and at least one second open position, which opens the second discharge path. The previous and following explanations regarding the initial valve element can also be applied to the second valve element and vice versa. Accordingly, in the second open position, the fluid can be and/or is discharged from the second working chamber via the second discharge path, since the second valve element in the second open position releases the second discharge path for a flow of the fluid from the second working chamber through the second discharge path. In the second closed position, however, the second valve element subsequently closes the second discharge path so that the fluid cannot flow through the second discharge path and, in particular, so that the fluid cannot be discharged from the second working chamber via the second discharge path.

The actuator device also comprises an initial actuating path which is fluidically connected to the first flow path at a first branch point which is arranged downstream of the pump device and upstream of the first working chamber. At the first branching point, a portion of the fluid which is conveyed by the pump device and, in particular as a result thereof, is thereby flowing through the first flow path can be branched off from the first flow path and introduced into the first actuation path and via which the second valve element can be actuated by means of the fluid introduced into the first actuation path and flowing through the first actuation path and can thereby be moved from the second closed position into the second open position.

The actuator device is also equipped with a second actuating path which is fluidically connected to the second flow path at a second branch point that is arranged downstream of the pump device and upstream of the second working chamber. At the second branch point, a portion of the fluid which is conveyed by the pumping device and, in particular, is thereby flowing through the second flow path can be branched off from the second flow path and introduced into the second actuation path. The first valve element can be actuated via the second actuation path by means of the fluid that has been introduced into the second actuation path and is flowing through the second actuation path and can therefore be moved from the first closed position to the first open position. In particular, it is provided that by moving the first valve element from the first closed position into the first open position, that the fluid can be discharged from the first working chamber via the first discharge path, therefore enabling fluid to be discharged from the first working chamber via the first discharge path. Furthermore, it is conceivable that by moving the second valve element from the second closed position to the second open position, the fluid can be discharged from the second working chamber via the second discharge path, therefore enabling the fluid to be discharged from the second working chamber via the second discharge path.

The invention enables so-called four-quadrant operation of the actuator device in a particularly simple manner and, in especially with the exception of the pumping device, without the use of active components and, in particular, only by pumping the fluid by means of the pumping device. Four-quadrant operation means, for example, that the aforementioned drive unit element can be moved actively i.e. by pumping the fluid by means of the pumping device, in the first direction of movement and in the second direction of movement, whereby the active movement of the drive unit element in the first direction of movement is considered as a first quadrant and the active movement of the drive unit element in the second direction of movement is thereby the second quadrant, so to speak, and passive movement of the drive unit element in the first direction of movement and in the second direction of movement can be permitted. Passive movement of the drive unit element means that an external force acts on the drive unit element. If, for example, the external force acts in the first direction of movement, so that the force is a tensile force, for example, and the drive unit element is therefore pulled in the first direction of movement, then a movement of the drive unit element in the first direction of movement, in particular a controlled movement, is permitted. If, for example, an external force acts on the drive unit element in the second direction of movement, so that the external force is, for example, a compressive force, then a controlled movement of the drive unit element in the second direction of movement is permitted. The passive movement of the drive unit element in the first direction of movement is, for example, a third quadrant and the passive movement of the drive unit element in the second direction of movement is, for example, a fourth quadrant. In particular, the respective passive movement can therefore be a controlled and/or active braking of the drive unit element. In particular, controlled throttling can occur during active braking, whereby, for example, braking energy results in heating of the fluid and/or kinetic energy is converted into thermal energy, whereby the fluid is subsequently heated. In other words, by or during the active movement of the drive unit element in the first direction of movement, for example, the drive unit element provides an initial force, in particular a first compressive force, which thereby acts in the first direction of movement. During or as a result of the active movement of the drive unit element in the second direction of movement, for example, the drive unit element provides a second force, in particular a tensile force, which subsequently acts in the second direction of movement. If, for example, a third force, in particular a tensile force, which is acting in the first direction of movement is exerted on the drive unit element, then the actuator device can permit a resulting movement of the drive unit element in the initial direction of movement, in particular a passive, in particular controlled movement, so that, for example, the drive unit element is moved, in particular pulled, in the initial direction of movement. If, for example, a fourth force, in particular a compressive force, which is acting in the second direction of movement is exerted on the drive unit element, then the actuator device can permit a resulting movement of the drive unit element in the second direction of movement, so that the drive unit element is pushed, in particular pulled, in the second direction of movement. These different movements and/or movement possibilities of the drive unit element can respectively be realized in a particularly simple manner and in particular only by the fact that the fluid is conveyed, in particular optionally, into the first working chamber or the second working chamber by means of the pump device. In particular, the described movement possibilities of the drive unit element can be realized without active, in particular actively switchable, elements which are separate from the pumping device, so that the number of parts, the installation space requirement, the weight and the costs of the actuator device can be retained at a particularly low level. The pumping device is preferably designed, in particular only designed, to be able to convey, i.e. pump, the fluid into the respective working chamber, so that the pumping device is preferably not capable of actively conveying the fluid out of the respective working chamber. Despite this design of the pumping device, the four-quadrant operation which has been described above can be realized in particular by the working chambers being coupled to one another in the manner described.

The respective valve element is preferably designed as a normally closed valve. This means in particular that the respective valve element assumes its respective closed position, in particular whenever it is not actuated by means of the fluid, whereby the respective valve element returns to its respective closed position, in particular automatically or autonomously, especially whenever the actuation of the respective valve element by means of the fluid ends. Therefore, it is preferably provided that the respective valve element can be moved from the respective closed position into the respective open position and can be subsequently retained in the respective open position by this and very preferably only by this when the respective valve element is actuated by means of the fluid.

In order to be able to realize the four-quadrant operation and therefore a particularly advantageous movability, or possibility for movement of the drive unit element or the drive unit device in a particularly simple manner, it is hereby provided in one embodiment of the invention that the first valve element is assigned a first actuating area and a first actuating chamber which is at least partially and directly bounded by the first actuating area, into which the fluid introduced into the second actuation path and flowing through the second actuation path can be introduced, whereby the first actuation region can be acted upon, in particular directly, by the fluid introduced into the second actuation path, flowing through the second actuation path and introduced into the first actuation chamber, whereby the first valve element can be moved from the first closed position into the first open position.

It has been shown to be particularly advantageous if the first actuating area and the first actuating chamber are assigned a first flow-limiting element which is connected or arranged parallel to the first actuating chamber and the first actuating area in the direction of flow of the fluid flowing through the second actuating path and into the first actuating chamber, in particular in terms of flow. The fluid can be discharged from the first actuating chamber via the first flow-limiting element in order to thereby cause or permit a movement of the first valve element from the first open position into the first closed position. When, for example, the pumping device conveys the fluid through the second flow path and therefore into the second working chamber via the second flow path, then the first actuation area is acted upon by the fluid conveyed by the pumping device, and therefore the first valve element is actuated, since at the second branching point a portion of the fluid conveyed by the pumping device and flowing through the second flow path is branched off from the second flow path and used to actuate the first valve element, i.e. in order to introduce the fluid into the first actuating chamber. If this delivery of the fluid is now terminated, then the fluid can flow out of the first actuation chamber, in particular bypassing the pump device, via the first flow restricting element, so that the first valve element, which was moved into the first open position by the previous actuation and is therefore initially in the first open position, can return and/or returns from the first open position to the first closed position. For example, the first flow-limiting element is arranged in a first discharge path via which the fluid can be discharged from the first actuation chamber. The first flow restricting element has a physical characteristic or imparts a physical characteristic to the first discharge path, in particular with regard to a flow of the fluid from the first actuating chamber through the first discharge path. In particular, the first flow limiting element is a functional element which permits pressure equalization between the first actuation chamber and, for example, a receiving area into which the fluid from the first actuation chamber can be guided via the first emptying path.

For example, the respective flow restricting element is a non-linear or proportional flow restricting element, whereby a flow or a flow of the fluid through the flow restricting element i.e. a volume and/or mass flow of the fluid through the flow restricting element is considered to be pressure-dependent i.e. it depends on a pressure of the fluid flowing through the flow restricting element.

In order to be able to realize the four-quadrant operation in a particularly simple manner, it is hereby provided in an additional embodiment of the invention that the second valve element is assigned a second actuating region and a second actuating chamber, which is at least partially and directly bounded by the second actuating region, wherein the second actuating chamber is provided in addition to the first actuating chamber and in particular is arranged outside the first actuating chamber, and whereby preferably the first actuating chamber is provided in addition to the second actuating chamber and is arranged outside the second actuating chamber. The fluid which is introduced into the first actuating path and flowing through the first actuating path can be introduced into the second actuating chamber, whereby the second actuating region can be acted upon, in particular directly, by the fluid introduced into the first actuating path and which is flowing through the first actuating path and introduced into the second actuating chamber. As a result, the second valve element can be moved from the second closed position to the second open position. The previous and following explanations relating to the first actuation area and the first actuation chamber can also be readily transferred to the second actuation area and the second actuation chamber and vice versa.

It has been shown to be particularly advantageous when the second actuating area and the second actuating chamber are assigned with a second flow-limiting element, which is connected parallel to the second actuating chamber and the second actuating area in the flow direction of the fluid flowing through the first actuating path and flowing into the second actuating chamber, whereby the fluid can be discharged from the second actuating chamber via the second flow-limiting element in order to thereby cause, or permit, a movement of the second valve element from the second open position into the second closed position.

For example, when the pumping device conveys the fluid through the first flow path and therefore into the first working chamber via the first flow path, then the second actuating area is acted upon by the fluid conveyed by the pumping device, and therefore the second valve element is actuated because, at the first branching point, a portion of the fluid conveyed by the pumping device and flowing through the first flow path is branched off from the first flow path and utilized in order to actuate the second valve element i.e. to introduce the fluid into the second actuating chamber. If this delivery of the fluid is now terminated, then the fluid can flow out of the second actuation chamber, in particular bypassing the pump device, via the second flow-limiting element, so that the second valve element, which was moved into the second open position by the previous actuation and is therefore initially in the second open position, can return or returns from the second open position to the second closed position. For example, the second flow-limiting element is hereby arranged in a second discharge path, via which the fluid can be discharged from the second actuation chamber. The second flow restricting element has a physical characteristic or imparts a physical characteristic to the second discharge path, in particular with regard to a flow of the fluid from the second actuating chamber through the second discharge path. In particular, the second flow limiting element is a functional element which permits pressure equalization between the second actuation chamber and, for example, the receiving area into which the fluid from the second actuation chamber can be fed via the second emptying path.

In order to be able to realize the four-quadrant operation without an excessive number of active, i.e. in particular actively switchable, elements and therefore in a particularly simple and cost-effective manner, it is provided in an additional embodiment of the invention that a first non-return valve is arranged in the first flow path downstream of the first branch point and upstream of the first working chamber, which can therefore prevent a flow of the fluid through the first flow path in the direction of the first branch point i.e. it closes in the direction of the first branch point, and permits a flow of the fluid through the first flow path in the direction of the first working chamber i.e. opens in the direction of the first working chamber. It has also proved to be particularly advantageous when a second non-return valve is arranged in the second flow path downstream of the second branch point and upstream of the second working chamber, which prevents the fluid from flowing through the second flow path in the direction of the second branch point i.e. closes in the direction of the second branch point, and thereby permits the fluid to flow through the second flow path in the direction of the second working chamber i.e. opens in the direction of the second working chamber. As a result, four-quadrant operation can be realized in a particularly simple and cost-effective manner, since an excessive number of active and, in particular, actively switchable elements can be prevented in this case.

In order to be able to realize a particularly advantageous movability of the drive unit device, in particular of the drive unit element, in a particularly cost-effective manner, one embodiment of the invention the pumping device is equipped with the solid-state actuator as an initial solid-state actuator, which is assigned to the first flow path, whereby the fluid can be conveyed through the first flow path by means of the initial solid-state actuator. Furthermore, the pumping device is equipped with a second solid-state actuator assigned to the second flow path, by means of which the fluid can be conveyed through the second flow path.

In order to be able to keep the number of parts and therefore the costs, weight and installation space requirements of the actuator device particularly low, it is provided in an additional embodiment of the invention that the pump device is equipped with a solid-state actuator as a solid-state actuator common to the first flow path and the second flow path, by means of which the fluid can be conveyed. The pump device indicates a valve device which can be switched between a first switching state and a second switching state. For example, the valve device is arranged upstream of the flow paths and downstream of the solid-state actuator in the direction of flow of the fluid flowing through the respective flow path. In particular, it is conceivable that the flow paths are therefore connected i.e. arranged, parallel to each other in terms of flow.

In the first switching state, the fluid which is conveyed by means of the solid-state actuator can be introduced into the first flow path via the valve device and subsequently conveyed through the first flow path. Furthermore, in the first switching state, the introduction of the fluid conveyed by means of the solid-state actuator into the second flow path via the valve device is prevented by means of the valve device. In other words, the solid-state actuator is only designed to convey the fluid into, in particular exactly, one conveying device. If the fluid is now conveyed by means of the solid-state actuator, in particular in the conveying direction, while the valve device is in the first switching state, the fluid conveyed by means of the solid-state actuator is introduced into the first flow path by means of the valve device, and the valve device prevents the fluid conveyed by means of the solid-state actuator from flowing into the second flow path.

In the second switching state, the fluid conveyed by means of the solid-state actuator, in particular in the conveying direction, can be introduced into the second flow path via the valve device and conveyed through the second flow path and, in the second switching state, the introduction of the fluid which is conveyed by means of the solid-state actuator into the first flow path via the valve device is prevented by means of the valve device. In other words, when the fluid is conveyed by means of the solid-state actuator, in particular in the conveying direction, while the valve device is in the second switching state, then the fluid which is conveyed by means of the solid-state actuator, in particular in the conveying direction, is directed into the second flow path by means of the valve device and the valve device prevents the fluid conveyed by means of the solid-state actuator, in particular in the conveying direction, from flowing into the first flow path.

In order to be able to retain the weight, the costs and the installation space requirement of the actuator device as especially low, it is provided in an additional embodiment of the invention that the solid-state actuator is arranged in a third flow path which is arranged upstream of the valve device, via which the fluid conveyed through the third flow path by means of the solid-state actuator and in particular conveyed in the conveying direction is to be guided to the valve device.

In an additional, particularly advantageous embodiment of the invention, the actuating device is equipped with the aforementioned drive unit element, which partially and directly delimits each of the working chambers. The feature that the drive unit element directly delimits the working chambers i.e. both working chambers, is to be understood as meaning that the fluid which is introduced into the respective working chamber and therefore received in the respective working chamber directly contacts the drive unit element.

The drive unit element is preferably, in particular translationally and/or rotationally and/or oscillatingly, movably accommodated in a housing, which partially delimits each of the working chambers. By introducing the fluid into the first working chamber, the drive unit element can therefore be acted upon directly by the fluid introduced into the first working chamber and can subsequently be moved in the first direction of movement relative to the housing, in particular translationally and/or rotationally and/or oscillatingly. By introducing the fluid into the second working chamber, the drive unit element can be acted upon directly by the fluid which is introduced into the second working chamber and can therefore be moved in the second direction of movement, hereby opposite to the first direction of movement, relative to the housing, in particular translationally and/or rotationally and/or oscillatingly.

It has hereby proven to be particularly advantageous when the drive unit element can be moved in the respective direction of movement relative to the housing in a translatory and/or rotatory and/or oscillating manner. The drive unit element can therefore, for example, include a piston and, in particular, a piston rod connected to the piston and movable with the piston, via which, for example, the aforementioned forces can be provided or exerted on the drive unit element.

It is also conceivable that the drive unit device is equipped with an initial bellows, in particular a first bellows, which limits the first drive unit chamber, in particular directly. It is also conceivable that the drive unit device is equipped with a second bellows, in particular a second bellows, which delimits the second drive unit chamber, in particular directly. It is conceivable that the respective bellows includes a respective folded area and in particular a respective base, which can be moved in the respective direction of movement, in particular translationally, for example by altering the length of the respective folded area and the associated alteration in volume of the respective working chamber. Therefore, for example, the first base is the first drive unit element, and the second base is, for example, the second drive unit element.

In order to be able to realize a particularly advantageous movability or possibility of movement of the drive unit device, in particular of the drive unit element, it is provided in an additional embodiment of the invention that one of the drive unit chambers, in particular exactly one of the drive unit chambers, is assigned a freewheel valve, via which the fluid can be introduced from a reservoir into the one working chamber by bypassing the pump device and preferably also by bypassing the other working chamber and preferably by bypassing the non-return valves and very preferably by bypassing the discharge paths and very preferably by bypassing the valve elements, wherein the freewheel valve opens in the direction of the one working chamber and closes in the direction of the reservoir. For example, the reservoir is deemed to be the aforementioned receiving area. The feature that the freewheel valve opens in the direction of the one working chamber and closes in the direction of the reservoir means that the freewheel valve permits a flow of the fluid from the reservoir to and into the one working chamber and prevents a flow of the fluid from the one working chamber into the reservoir. The freewheel valve therefore acts as a kind of non-return valve, by means of which a particularly rapid movement of the drive unit device, in particular of the drive unit element, can therefore be permitted, in particular in one of the directions of movement.

The feature in this case that the fluid can be introduced from the reservoir into the working chamber via the freewheel valve, bypassing the pump device and preferably bypassing the other working chamber, the non-return valves, the discharge paths and/or the valve element, is to therefore be understood that the fluid flowing from the reservoir via the free-flow valve into the one working chamber bypasses the pump device and preferably the other working chamber, the non-return valves, the discharge paths and/or the valve element, and therefore does not flow through the pump device and does not flow through the other working chamber and does not flow through the non-return valves and does not flow through the discharge paths and does not flow through the valve elements. A second aspect of the invention relates to a method of operating an actuator device, in particular according to the first aspect of the invention. In the method according to the second aspect of the invention, the actuator device is equipped with a minimum of two working chambers, which are also referred to as drive unit chambers. The working chambers are coupled to each other in such a way that an increase in volume of a first of the working chambers is accompanied, in particular simultaneously, by a reduction in volume of the second working chamber and vice versa. The actuator device is equipped with a drive unit device which is driven by the respective increase in volume of the respective working chamber and therefore moved. The actuator device comprises a pumping device including a minimum of having at least one solid actuator, by means of which a fluid is conveyed, in particular in exactly one conveying direction. The actuator device comprises a first flow path through which the fluid conveyed by the pumping device can flow, in particular in the conveying direction and via which the fluid, which is conveyed by the pumping device and flowing through the first flow path, is thereby introduced into the first working chamber in order to increase the volume of the first working chamber. Furthermore, the actuator device comprises a second flow path through which fluid conveyed by the pumping device, in particular in the conveying direction, can flow and via which the fluid conveyed by the pumping device and flowing through the second flow path is subsequently introduced into the second working chamber in order to effect the increase in volume of the second working chamber. The actuator device includes a first discharge path associated with the first working chamber, via which the fluid is discharged from the first working chamber in order to reduce the volume of the first working chamber. Furthermore, the actuator device comprises a second discharge path which is associated with the second working chamber, via which the fluid is discharged from the second working chamber in order to reduce the volume of the second working chamber.

The actuator device also comprises a first valve element which is arranged in the first discharge path, which is moved between a first closed position, which closes the first discharge path and a minimum of one first open position, which opens the first discharge path. The actuator device also comprises a second valve element which is arranged in the second discharge path, which is moved between a second closed position closing the second discharge path and a a minimum of one second open position releasing the second discharge path.

The actuator device also comprises a second valve element which is arranged in the second discharge path, which is moved between a second closed position closing the second discharge path and a minimum of one second open position releasing the second discharge path. Furthermore, a first actuation path is provided, which is fluidically connected to the first flow path at a first branch point which is arranged downstream of the pump device and upstream of the first working chamber. At the first branching point, a portion of the fluid conveyed by the pumping device and flowing through the first flow path is thereby branched off from the first flow path and subsequently introduced into the first actuation path. The second valve element is actuated via the first actuation path by means of the fluid which is introduced into the first actuation path and flowing through the first actuation path, thereby moving it from the second closed position to the second open position.

Furthermore, the actuator device includes a second actuating path which is fluidically connected to the first flow path at a second branch point, which is arranged downstream of the pumping device and upstream of the second working chamber. At the second branch point, a portion of the fluid which is conveyed by the pumping device and flowing through the second flow path is branched off from the second flow path and subsequently introduced into the second actuation path. The first valve element is actuated via the second actuation path by means of the fluid which is introduced into the second actuation path and flowing through the second actuation path, thereby moving it from the first closed position to the first open position. Advantages and advantageous embodiments of the first aspect of the invention are to be regarded as advantages and advantageous embodiments of the second aspect of the invention and vice versa.

Additional advantages, features and details of the invention can be seen from the following description of preferred embodiments and from the provided drawing. The features and combinations of features mentioned above in the description as well as the features and combinations of features mentioned below in the description of the figures and/or represented alone in the figures can be utilized not only in the combination indicated in each case, but also in other combinations or on their own, without departing from the scope of the invention.

### BRIEF DESCRIPTION OF THE DRAWINGS

In the drawings:

FIG. 1A schematic representation of a first embodiment of an actuator device;

FIG. 2A schematic representation of a second embodiment of the actuator device;

FIG. 3A schematic representation of a third embodiment of the actuator device; and

FIG. 4A schematic representation of a section of a fourth embodiment for the actuator device.

In the figures, identical or functionally identical elements are marked with the same reference symbols.

### DETAILED DESCRIPTION

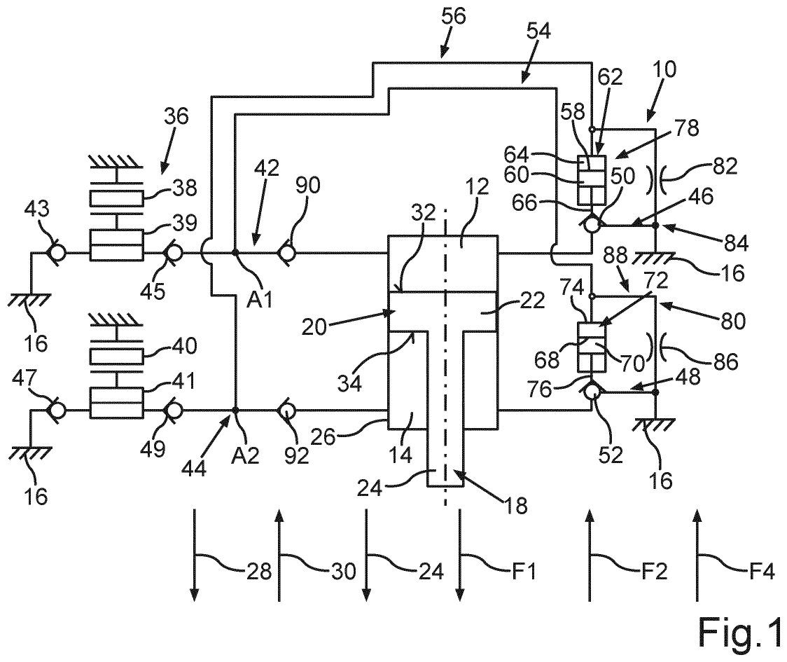

FIG. 1 represents a schematic representation of a first embodiment of an actuator device 10, by means of which, for example, at least one force or several forces can be exerted on an object. This can be utilized, for example, to move the object, or the object can be braked or clamped, in particular in an active and/or controlled manner, and therefore, for example, actively secured against movement. Alternatively or additionally, the object can, for example, be moved and/or deformed and/or compacted. In the first embodiment, the actuator device 10 has exactly two working chambers 12 and 14, which are also referred to as drive unit chambers. The working chambers 12 and 14 are coupled to one another in such a way that an increase in volume of the working chamber 12, in particular simultaneously, is accompanied by a reduction in volume of the working chamber 14, and that an increase in volume of the working chamber 14 is accompanied by a reduction in volume of the working chamber 12, in particular simultaneously. A reservoir 16 is shown particularly schematically in FIG. 1, in which a fluid, preferably in the form of a liquid, can be accommodated or is accommodated. The reservoir 16 is also referred to as a mass.

The actuator device 10 indicates a drive unit device 18 which can be driven by the respective increase in volume of the respective working chamber 12, 14 and can therefore be moved. In the first embodiment, the drive unit device 18 has a a minimum of or, in the present case, precisely one drive unit element 20, which comprises a piston 22 and, in particular precisely, a piston rod 24. In this case, the actuator device 10 comprises a housing 26 in which the drive unit element 20, in particular the piston 22, is movably accommodated. In the first embodiment, the drive unit element 20 and therefore the drive unit device 18 are moved translationally relative to the housing 26 in a first direction of movement and in a second direction of movement. The first direction of movement is illustrated by an arrow 28, and the second direction of movement is illustrated by an arrow 30. It can be seen from the arrows 28 and 30 that the directions of movement are parallel to each other, with the second direction of movement being opposite to the first direction of movement. The drive unit element 20, in particular the piston 22, directly and partially delimits both the working chamber 12 and the working chamber 14, whereby the working chamber 12 and the working chamber 14 are each partially delimited directly by the housing 26. It can be seen that the working chamber 12 is arranged in particular along the respective direction of movement on a first side 32 of the piston 22 or of the drive unit element 20, and the working chamber 14 is arranged on a second side 34 of the piston 22 or of the drive unit element 20, with the side 34 facing away from the side 32 along the respective direction of movement or vice versa. This means that in the first embodiment, the working chambers 12 and 14 are arranged on the sides 32 and 34 of the drive unit element 20, in particular of the piston 22, which are opposite one another along the direction of movement. The side 32 partially and directly delimits the working chamber 12, and the side 34 partially and directly delimits the working chamber 14. Since, as can be seen from FIG. 1, the piston rod 24 is arranged at least partially in the working chamber 14, the increase in volume of the working chamber 12 does not occur to the same extent as the reduction in volume of the working chamber 14, and the increase in volume of the working chamber 14 does not occur to the same extent as the reduction in volume of the working chamber 12. Therefore, for example, if the drive unit element 20 is moved translationally a first distance in the second direction of movement relative to the housing 26, a first quantity of the fluid is conveyed out of the working chamber 12 and, in particular simultaneously, a second quantity of the fluid, which is smaller than the first quantity, is conveyed into the working chamber 14. In other words, for example, the volume of the working chamber 12 is reduced by a first volume unit, which is accompanied by an increase in the volume of the working chamber 14 by a second volume unit that is smaller than the first volume unit. In particular, the respective working chamber 12 or 14 is to be understood as a non-physical space enclosed or directly bounded by the housing 26 and the drive unit element 20, in which the fluid can be accommodated.

The actuator device 10 indicates an additional pumping device 36 which, in the first embodiment as shown in FIG. 1, demonstrates a solid-state actuator 38 as a first solid-state actuator and a second solid-state actuator 40, the solid-state actuators 38 and 40 being separate and, in particular, spaced-apart components. By means of the pump device 36, the fluid can be conveyed from the reservoir 16, in particular in exactly one conveying direction. In other words, the respective solid-state actuator 38, 40 is preferably designed to convey the fluid from the reservoir 16 in exactly one, i.e. in a single conveying direction in each case.

It can be seen, for example, that a respective volume of a respective pump chamber can be changed by means of the respective solid actuator 38, 40, in particular in such a way that the respective volume of the respective pump chamber can be alternately increased and reduced. By increasing the respective volume of the respective pump chamber, the fluid is conveyed, in particular sucked in, from the reservoir 16 into the respective pump chamber, in particular via a respective non-return valve 43 or 47. The respective non-return valve 43, 47 permits a respective flow of the fluid from the reservoir 16 into the respective pump chamber, but prevents a flow from the respective pump chamber via the respective non-return valve 43, 47 back into the reservoir 16, in particular when the respective volume of the respective pump chamber is reduced. If the respective volume of the respective pump chamber is reduced, the fluid is thereby conveyed out of the respective pump chamber, in particular via a respective non-return valve 45 or 49.

The actuator device 10 has a first flow path 42 through which the fluid conveyed by the pump device 36, in particular by means of the solid-state actuator 38, can flow, wherein the solid-state actuator 38 is associated with the first flow path 42 and vice versa. The first flow path 42 is arranged upstream of the first working chamber 12 and downstream of the pump device 36 and therefore downstream of the associated solid-state actuator 38. Via the first flow path 42, the fluid conveyed by means of the pump device 36, in particular by means of the solid-state actuator 38, and flowing through the first flow path 42 can be introduced into the first working chamber 12 in order to effect the increase in volume of the first working chamber 12. The actuator device 10 also comprises a second flow path 44 through which fluid can flow by means of the pump device 36, in particular by means of the solid-state actuator 40. The solid-state actuator 40 is assigned to the flow path 44 and vice versa. The flow path 44 is arranged upstream of the second working chamber 14 and downstream of the pump device 36, in particular of the solid-state actuator 40. Via the second flow path 44, the fluid conveyed by means of the pump device 36, in particular by means of the second solid actuator 40, and flowing through the second flow path 44 can be introduced into the second working chamber 14 in order to effect the increase in volume of the second working chamber 14.

If the volume of the respective pump chamber is reduced, the fluid is thereby conveyed out of the respective pump chamber, in particular via the respective non-return valve 45, 49, and conveyed into the respective flow path 42, 44 and subsequently conveyed through the respective flow path 42, 44. The respective non-return valve 45, 49 thereby permits a respective flow of the fluid from the respective pump chamber into the respective flow path 42, 44, but prevents the fluid from flowing out of the respective flow path 42, 44 via the respective non-return valve 45, 49 back into the respective pump chamber, in particular when the volume of the respective pump chamber is reduced.

It can be recognized from FIG. 1 that, in the present case, the respective pump chamber is bounded, in particular directly and/or partially, by a respective pump piston 39 or 41, which can be moved in particular in translation relative to a respective pump housing partially and preferably directly bounding the respective pump chamber, in particular by means of the respective solid actuator 38, 40. By moving, in particular by moving the respective pump piston 39, 41 back and forth by means of the respective solid actuator 38, 40, the respective volume of the respective pump chamber can be alternately reduced and increased.

A first discharge path 46 is allocated to the first working chamber 12, via which the fluid can be discharged from the first working chamber 12 in order to reduce the volume of the first working chamber 12 and, in particular, can therefore be introduced into the reservoir 16. A second discharge path 48 is allocated to the second working chamber 14, via which the fluid can be discharged from the second working chamber 14 in order to reduce the volume of the second working chamber 14 and, in particular, can therefore be introduced into the reservoir 16. It can be recognized that the respective solid actuator 38, 40 can thereby convey the fluid from the reservoir 16 and, in doing so, can convey it through the respectively associated flow path 42, 44 and via the respectively associated flow path 42, 44 into the respectively associated working chamber 12, 14, whereby the working chamber 12 is associated with the flow path 42 and vice versa, and wherein the working chamber 14 is associated with the flow path 44 and vice versa. The fluid can be discharged from the working chamber 12 via the discharge path 46 and, in particular, back into the reservoir 16 and the fluid can be discharged from the working chamber 14 via the discharge path 48 and, in particular, back into the reservoir 16.

An initial valve element 50 is arranged in the first discharge path 46, which can be moved between a first closed position, thereby closing the first discharge path 46 and a minimum of one first open position releasing the first discharge path 46. A second valve element 52 is arranged in the second discharge path 48, which is movable between a second closed position, thereby closing the second discharge path 48 and a minimum of one second open position, thereby releasing the second discharge path 48. For example, the respective valve element 50, 52, in particular purely, can be moved translationally between the respective closed position and the respective open position, in particular as relative to a valve housing which is not represented in more detail in FIG. 1.

The actuator device 10 indicates an initial actuation path 54, which is fluidically connected to the first flow path 42 at a first branch point A1 arranged downstream of the pump device 36, in particular downstream of the solid-state actuator 38 and upstream of the first working chamber 12. At the first branch point A1, a portion of the fluid which is conveyed by means of the pump device 36, in particular by means of the solid-state actuator 38, and flowing through the first flow path 42 can be subsequently branched off from the first flow path 42 and introduced into the initial actuation path 54. The second valve element 52 can be actuated via the initial actuation path 54 by means of the fluid which is introduced into the initial actuation path 54 and flowing through the initial actuation path 54 and can thereby be moved from the second closed position into the second open position and, in particular, can be held in the second open position, for example. Furthermore, the actuator device 10 comprises a second actuation path 56, which is fluidically connected to the second flow path 44 at a second branch point A2, which is arranged downstream of the pump device 36, in particular of the solid-state actuator 40, and upstream of the second working chamber 14. At the second branch point A2, a portion of the fluid which is conveyed by means of the pump device 36, in particular by means of the solid-state actuator 40, and flowing through the second flow path 44, can be branched off from the second flow path 44 and introduced into the second actuation path 56. The first valve element 50 can be actuated via the second actuation path 56 by means of the fluid which is introduced into the second actuation path 56 and flowing through the second actuation path 56 and can therefore be moved from the first closed position into the first open position and, in particular, can be retained in the first open position.

In the first embodiment, the first valve element 50 is assigned with a first actuating region 58, which is formed by a first actuating piston 60 designed as a solid body, in particular by a surface of the actuating piston 60. In addition, the valve element 50 is assigned a first actuating chamber 62 which is bounded directly by the actuating region 58 and therefore by the actuating piston 60 and which is partially and directly bounded by the actuating region 58 and therefore by the actuating piston 60 and partially and directly by a first actuating housing 64. The first actuating piston 60 is accommodated in the first actuating housing 64 in order for it to be movable, in particular translationally, and is connected to the first valve element 50, in particular via a first actuating piston rod 66. The actuating piston 60 and the valve element 50 and in particular the actuating piston rod 66 can therefore be moved together or simultaneously and preferably translationally relative to the first actuating housing 64, in particular between the first open position and the first closed position. The fluid which is introduced into the second actuating path 56 and is subsequently flowing through the second actuating path 56 can be introduced into the actuating chamber 62 via the second actuating path 56, whereby the first actuating region 58, and therefore the first actuating piston 60, is directly connected to the fluid which is introduced into the second actuating path 56, the second actuation path 56 and subsequently introduced into the first actuation chamber 62 via the second actuation path 56, whereby the first valve element 50 can be moved from the first closed position into the first open position, in particular translationally and relative to the actuation housing 64.

The second valve element 52 is assigned a second actuating region 68, which is formed by a second actuating piston 70 and designed as a solid body, in particular by a surface of the second actuating piston 70. Moreover, the valve element 52 is assigned a second actuating chamber 72, which is at least partially and directly bounded by the second actuating region 68 and therefore by the second actuating piston 70. In addition, the second actuating chamber 72 is partially and directly bounded by a second actuating housing 74, in which the second actuating piston 70 is accommodated in order for it to movable, in particular translationally. The second actuating piston 70 is connected, in particular via a second actuating piston rod 76, to the second valve element 52, so that the second valve element 52 and the second actuating piston 70 and in particular the second actuating piston rod 76 can be moved, in particular jointly or simultaneously, relative to the second actuating housing 74, in particular translationally, in particular between the second closed position and the second open position. The fluid which is introduced into the first actuating path 54 and flowing through the first actuating path 54 can be introduced into the second actuating chamber 72 via the first actuating path 54, whereby the second actuating region 68, and therefore the second actuating piston 70, can be directly connected to the fluid which is introduced into the first actuating path 54, the first actuating path 54 and introduced into the second actuating chamber 72 via the first actuating path 54, whereby the second valve element 52 and, for example, the second actuating piston 70 and in particular the second actuating piston rod 76 can be moved, in particular relative to the actuating housing 74 and/or translationally, from the second closed position into the second open position.

As an alternative to the respective actuating piston 60 and/or 70, a bellows, in particular a folding bellows, can be utilized. The same applies to all other pistons disclosed herein.

The actuating region 58 and therefore the actuating piston 60, the actuating chamber 62, the actuating housing 64 and the actuating piston rod 66 are components of and/or create an actuating unit 78, via which the valve element 50 can be actuated by means of the fluid which is flowing through the actuating path 56 and can therefore be moved from the first closed position into the first open position. Accordingly, the actuating region 68 and the actuating piston 70, the actuating chamber 72, the actuating housing 74 and the actuating piston rod 76 are and/or create a second actuating unit 80, via which the valve element 52 can be actuated by means of the fluid which is flowing through the first actuating path 54 and can therefore be moved from the second closed position into the second open position. The respective valve element 50, 52 is a normally closed valve which, when it is not actuated, automatically returns to its respective closed position or assumes its respective closed position. The actuation unit 78, and therefore the first actuation area 58 and the first actuation chamber 62, are associated with a first flow limiting element 82, which is arranged in a first emptying path 84. The first flow restricting element 82 and the first emptying path 84 are connected in parallel to the actuating unit 78 in the flow direction of the fluid which is flowing through the second actuating path 56 and flowing into the first actuating chamber 62. The fluid can be discharged from the first actuation chamber 62 via the first discharge path 84 and therefore via the first flow restricting element 82 and, in particular, can be introduced into reservoir 16 in order to thereby cause or permit a movement of the first valve element 50 from the first open position to the first closed position. Accordingly, the actuation unit 80, and therefore the second actuation area 68 and the second actuation chamber 72, is associated with a second flow restricting element 86, which is arranged in a second emptying path 88. The emptying path 88 and the flow-limiting element 86 are connected in parallel to the actuating unit 80 in the flow direction of the fluid which is flowing through the first actuating path 54 and flowing into the second actuating chamber 72. The fluid can be discharged from the second actuating chamber 72 and introduced into reservoir 16 via the discharge path 88 and therefore via the second flow-limiting element 86, in order thereby to cause or permit a movement of the second valve element 52 from the second open position into the second closed position.

The respective flow restricting element 82, 86 can be a throttle such as, for example, a rigid and therefore non-adjustable throttle or an adjustable, in particular controllable, throttle. The flow restricting element 82, 86 can be an active or passive element, for example to effect or permit a flow of the fluid from the respective actuating chamber 62, 72, in particular into the reservoir 16, which can in particular be controlled, regulated or adjusted. In particular, the respective flow restricting element 82, 86 is considered to be a functional element which permits pressure equalization between the respective actuating chamber 62, 72 and the reservoir 16 and/or, in particular subsequently, pressure equalization between the working chambers 12 and 14. The flow restricting element 82, 86 can be a linear element i.e. indicate a linear behavior, in particular in such a way that a higher pressure, in particular prevailing in the respective discharge path 84, 88, leads to a higher flow rate of the fluid through the respective flow restricting element 82, 86, or the flow-limiting element 82, 86 is a constant flow element and/or a flow regulator, in particular in such a way that a flow of the fluid through the respective flow-limiting element 82, 86 remains or is constant irrespective of a pressure of the fluid prevailing in particular in the respective discharge path 84, 88. In particular, for example when the flow-limiting element 82, 86 is a throttle, then the flow-limiting element 82, 86 is a linear element and therefore exhibits a proportional or degressive behavior, that is, in particular, a constant proportional or constant degressive behavior.

Furthermore, it can be seen from FIG. 1 that a first non-return valve 90 is arranged in the first flow path 42 downstream of the first branch point A1 and upstream of the working chamber 12, which thereby prevents the fluid from flowing through the first flow path 42 in the direction of the first branch point A1 and permits it to flow in the direction of the first working chamber 12. A second non-return valve 92 is arranged in the second flow path 44 downstream of the second branch point A2 and upstream of the second working chamber 14, which prevents the fluid from flowing through the second flow path 44 in the direction of the second branch point A2 and enables it to flow in the direction of the second working chamber 14.

The actuator device 10 can be operated in a four-quadrant mode. In other words, the actuator device 10 enables four-quadrant operation, which is explained below:

For example, in a first operating state, the pump device 36, in particular the solid-state actuator 38, conveys the fluid, in particular from the reservoir 16, into the working chamber 12 via the flow path 42, in particular while the fluid is not conveyed into the working chamber 14 by means of the pump device 36, in particular by means of the solid-state actuator 40, and in particular while the fluid is not conveyed, in particular completely, by means of the solid-state actuator 40. On the one hand, this causes an increase in the volume of the working chamber 12 and an associated reduction in the volume of the working chamber 14, in particular by the fact that, at the branch point A1, a portion of the fluid which is conveyed by means of the pump device 36, in particular by means of the solid-state actuator 38, and is flowing through the flow path 42 is branched off, introduced into the actuation path 54 and introduced into the actuation chamber 72 by means of the actuation path 54. As a result, the valve element 52 is actuated and thereby moved from the second closed position to the second open position, so that, in order to permit the volume reduction of the working chamber 14, the fluid can flow out of the working chamber 14 via the discharge path 48 and therefore via the valve element 52 and, in particular, flow into reservoir 16. As a result, the drive unit element 20 is moved in the first direction of movement illustrated by the arrow 28, in particular translationally and/or relative to the housing 26. In particular, for example, the drive unit element 20 is thereby moved from a first position into a second position which is different from the first position. When the delivery of the fluid into the working chamber 12 is terminated and fluid is not delivered into the working chamber 14, then the valve element 52 returns, in particular independently i.e. automatically, from the second open position to the second closed position, in particular in that at least a portion of the fluid initially received in the actuating chamber 72 is discharged from the actuating chamber 72 via the discharge path 88 and therefore via the flow restricting element 86 and, in particular, is guided into reservoir 16. As a result, the drive unit element 20 remains in the aforementioned second position. This means in particular that, when no fluid is conveyed into the working chambers 12 and 14 and the valve elements 50 and 52 are in their closed positions, then the actuator device 10, also referred to as the system or overall system, indicates a high impedance i.e. a high rigidity, and is therefore stiff, so that the drive unit element 20 remains in the second position i.e. in the position into which the drive unit element 20 was previously moved.

For example, in the first operating state and therefore when it is moved in the first direction of movement, the drive unit element 20 provides an initial force, which is illustrated in FIG. 1 by a force arrow F1. By means of the force F1, for example, an element provided in particular in addition to the drive unit element 20 and therefore also designated as an object can be moved and/or clamped, in particular in the first direction of movement illustrated by the arrow 28, in which the initial force (force arrow F1) acts. In particular, the initial force (force arrow F1) can act on the element as a compressive force from the drive unit element 20, so that, for example in the first operating state, the drive unit element 20 can press the object and/or on the object. The first operating state is an active operating state because, in the first operating state or due to the first operating state, the drive unit element 20 is actively moved in the first direction of movement, in that the fluid is actively conveyed into the working chamber 12 by means of the pump device 36, in particular by means of the solid-state actuator 38. The first operating state, i.e. the movement of the drive unit element 20 in the first direction of movement, is also referred to as the first quadrant or as movement in a first quadrant.

In a second operating state, for example, the pump device 36, in particular the solid-state actuator 40, conveys the fluid, in particular from reservoir 16 into the working chamber 14 via the flow path 44, in particular while the fluid is not conveyed into the working chamber 12 by means of the pump device 36, in particular by means of the solid-state actuator 38 and in particular while the fluid is not conveyed by means of the pump device 36, in particular by means of the solid-state actuator 38, in particular overall. This causes an increase in the volume of the working chamber 14, the increase in volume of which is accompanied by a reduction in the volume of the working chamber 12. The reduction in volume of the working chamber 12 is permitted in particular by the fact that at least a portion of the fluid which is conveyed by means of the pump device 36, in particular by means of the solid-state actuator 40, and is flowing through the flow path 44 is branched off at the branching point A2 and introduced into the actuation path 56 and thereby guided into the actuation chamber 62 by means of the actuation path 56. As a result, the valve element 50 is moved from its first closed position into its first open position, so that at least a portion of the fluid which is received in the working chamber 12 can flow through the discharge path 46 and therefore flow out of the working chamber 12 via the discharge path 46 and therefore via the valve element 50 and, in particular, flow into reservoir 16. It can be seen that, in the first operating state, the valve element 50 is closed, so that in the first operating state no fluid can flow out of the working chamber 12 via the discharge path 46, and in the second operating state the valve element 52 is closed, so that in the second operating state no fluid can flow out of the working chamber 14 via the discharge path 48.

In the, or by the, second operating state, the drive unit element 20 is moved, in particular translationally and/or relative to the housing 26, in the second direction of movement illustrated by the arrow 30, whereby, for example, the drive unit element 20 is moved from the second position back into the first position, from the second position into a third position which is considered to be different from the first position and the second position. If the delivery of the fluid into the working chamber 14 is terminated, in particular while the fluid is not being delivered into the working chamber 12, the valve element 50 returns, in particular automatically or autonomously, from its first open position to its first closed position, as a result of which the system again indicates a high impedance, i.e. a high rigidity, and the drive unit element 20 remains in the first position or in the third position i.e. in the position into which the drive unit element 20 was previously moved. The feature that the respective valve element 50 or 52 returns independently or automatically from a respective open position to its respective closed position is to be understood as meaning that the respective valve element 50 or 52 returns from its respective open position to its respective closed position without having to actively control, i.e. actuate, the valve element 50 or 52. In particular, the respective valve element 50 or 52 can only return from its respective open position to its respective closed position by ending the delivery of the fluid into the respective working chamber 14 or 12.

Furthermore, it is conceivable that the respective valve element 50, 52 is open i.e. is in its open position, when no fluid is conveyed into the working chamber 12 or 14. In other words, it is conceivable that the valve element 50, 52 returns to its open position, in particular independently, or remains open, i.e. remains in the open position, when the delivery of the fluid into the working chamber 12, 14 is thereby terminated. In particular, the respective valve element 50 or 52 respectively, in particular only, returns from its respective open position to its respective closed position independently or automatically, i.e. without having to actively actuate the respective valve element 50 or 52, due to pressure and/or flow conditions which are present in the system.

The second operating state, i.e. the movement of the drive unit element 20 in the second direction of movement, is also referred to as the second quadrant or movement in a second quadrant. The first operating state and the second operating state are motorized operating states i.e. motorized operations of the actuator device 10 because, in the first operating state and in the second operating state, the drive unit element 20 is moved in that the fluid is actively conveyed into the respective working chamber 12 or 14 by means of the pump device 36 in order to cause, in particular actively, an increase in volume of the respective working chamber 12 or 14.

For example, in or through the second operating state, the drive unit element 20 provides a second force, illustrated in FIG. 1 by a force arrow F2, which thereby acts here in the second direction of movement, illustrated by the arrow 30, in which the drive unit element 20 is moved in and/or through the second operating state, in particular translationally and/or relative to the housing 26. Since the force FI acts in the first direction of movement and the force F2 acts in the second direction of movement, then the second force F2 is opposite to the first force and vice versa. For example, the second force is a tensile force which acts, for example, from the drive unit element 20 on the aforementioned object. Therefore, for example, the object can be moved and/or tensioned by or in the second operating state by means of the drive unit element 20, in particular in the second direction of movement, or it is conceivable that, for example, when the object is tensioned by the first operating state, the object is relaxed or released by the second operating state. In particular, in the second operating state, the second force illustrated by the force arrow F2 can be exerted and/or act on the object by the drive unit element 20. Overall, it can be seen that, for example, in the first operating state, the initial force is provided by the drive unit element 20 and, in particular, acts on the object by the drive unit element 20, and in the second operating state, the second force is provided by the drive unit element 20 or the second force acts on the object by the drive unit element 20.

For example, in a third operating state of the actuator device 10, an external third force, illustrated by a force arrow F3, acts on the drive unit element 20, which subsequently acts in the first direction of movement (arrow 28). In particular, the third force acts as a tensile force on the drive unit element 20. For example, in order to enable the drive unit element 20 to be movable and/or moved by means of the third force in the first direction of movement, in particular translationally and/or relative to the housing 26, the following can be provided: As a result of the third force being exerted on the drive unit element 20 in the first direction of movement, a pressure is therefore created in the working chamber 12 which is at least temporarily or briefly lower than an initial level, in particular slightly, and a pressure is built up in the working chamber 14 which is higher than a pressure or the initial level, so that the non-return valve 92 and in particular at least predominantly or briefly also the valve element 52 are subsequently closed. In order to now permit a movement of the drive unit element 20 which is caused by the third force, the fluid, in particular that volume from reservoir 16, is conveyed by means of the pump device 36, in particular by means of the solid-state actuator 38, in particular while fluid is not being conveyed into the working chamber 14, in particular into the working chamber 12, whereby a pressure is built up in the working chamber 12, which increases until the valve element 52 is actuated and therefore opened, i.e. moved from its second closed position to its second open position, by the fact that the actuating chamber 72 is fluidically connected to the flow path 42 at the branch point A1. As a result, the fluid can subsequently flow out of the working chamber 14 via the now open discharge path 48, whereby the drive unit element 20 can move in the first direction of movement. As a result, a pressure lower than this and/or the initial level builds up in the working chamber 12, at least temporarily or briefly, as a result of which fluid is conveyed out of the actuating chamber 72 via the branch point A1 and via the actuating path 54, in particular is sucked out, as a result of which the valve element 52 is closed again. As a result, the drive unit element 20 can no longer move in the first direction of movement because fluid can no longer flow out of the operating chamber 14. As a result, the drive unit element 20 will and/or can move precisely at the pumping speed of the solid-state actuator 38, i.e. at the speed in the first direction of movement at which fluid is conveyed through the flow path 42 by means of the pumping device 36, in particular by means of the solid-state actuator 38. Due to the lowered pressure which is prevailing in the working chamber 12 at least temporarily or briefly, fluid is now conveyed into the working chamber 12 via the branch point A1 and the actuation path 54 and not via the first solid-state actuator 38, also referred to as the first pump, or not via the pump device 36, in particular it is now sucked because a flow of the fluid through the actuation path 54 and via the branch point A1 into the working chamber 12 is opposed by a lower pressure or a lower pressure difference than a flow of the fluid via the pump device 36. In other words, along a path of the fluid via the actuation path 54 and the branch point A1 into the working chamber 12, there is a lower pressure drop than along a path of the fluid via the pump device 36 into the working chamber 12. The movement of the drive unit element 20 in the first direction of movement, which is caused by the external third force, is also referred to as a third quadrant and/or movement in a third quadrant, wherein, because the drive unit element 20 is moved by means of the external third force, the third operating state is a quasi-generative operation or quasi-generative operating state.

For example, in a fourth operating state of the actuator device, an external fourth force, illustrated by a force arrow F4, is exerted on the drive unit element 20, the fourth force acting in the second direction of movement (arrow 30) and therefore opposing the third force F3. Therefore, for example, the fourth force (force arrow F4) acts as a compressive force on the drive unit element 20, in particular from the aforementioned object. The fourth operating state is a second regenerative operation or a second regenerative operating state of the actuator device 10, which fundamentally corresponds to the first regenerative operation, with the only difference being that, in the first regenerative operation (third operating state), the third force which acts in the first direction of movement, and in the second regenerative operation and therefore in the fourth operating state the fourth force, which acts in the second direction of movement, is exerted on the drive unit element 20 from the outside. As a result of the fourth force acting on the drive unit element 20 from the outside in the second direction of movement (arrow 30), a pressure lower than one or the initial level is created in the working chamber 14 at least temporarily or briefly and a higher or increased pressure compared to one or the initial level builds up temporarily or briefly in the working chamber 12, so that the non-return valve 90 and the valve element 50 are initially closed. Now, however, the pump device 36, in particular the solid-state actuator 40, in the fourth operating state conveys the fluid, in particular from reservoir 16, in particular into or in the direction of the working chamber 14, so that a pressure of the fluid would increase in the working chamber 14 until the valve element 50 is actuated by means of the fluid via the branch point A2 and the actuation path 56 and therefore moved into the first open position. As a result, the fluid can now flow out of the working chamber 12 via the discharge path 46 and the drive unit element 20 can, so to speak, evade or yield to the fourth force and therefore move in the second direction of movement, in particular translationally and/or relative to the housing 26. As a result, a lower pressure i.e. a lower pressure compared to an or the initial level, therefore builds up at least temporarily or briefly in the working chamber 14, whereby fluid is sucked out of the actuating chamber 62 via the branch point A2 and the actuating path 56. As a result, the valve element 50 is closed, i.e. moved into the first closed position, so that the drive unit element 20 can no longer move in the second direction of movement. The drive unit element 20 therefore moves in the second direction of movement precisely at a pumping speed from pumping device 36, in particular of the solid-state actuator 40, and therefore precisely at a speed at which the pumping device 36, in particular the solid-state actuator 40, conveys the fluid, in particular through the flow path 44. The lowered pressure which thereby builds up in the working chamber 14 subsequently draws fluid out of the actuating chamber 62 via the branch point A2 and the actuating path 56 and not via the pump device 36, in particular the solid-state actuator 40, because there is a lower pressure drop along a path of the fluid from the actuating chamber 62 via the actuating path 56 and the branch point A2 than along a path of the fluid from reservoir 16 via the pump device 36, in particular via the solid-state actuator 40, in the direction of and/or into the working chamber 14. The two motor operations and the two generator operations are, or therefore, create the four-quadrant operation, whereby a particularly advantageous movement, movability or possibility of movement of the drive unit element 20 and therefore of the drive unit device 18 is represented.

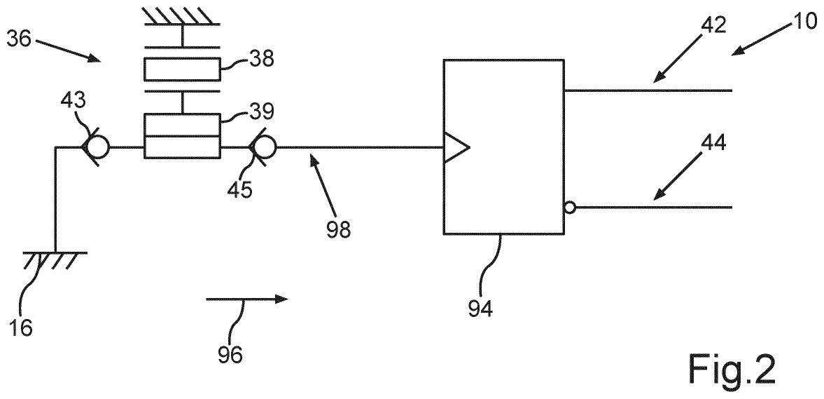

FIG. 2 shows a sectional schematic representation of a second embodiment of the actuator device 10. In the second embodiment, the pumping device 36 indicates the solid-state actuator 38 as a solid-state actuator, which is common to the first flow path 42 and the second flow path 44 for conveying the fluid. In addition, the pump device 36 comprises a valve device 94, which is arranged upstream of the flow paths 42 and 44 and downstream of the pump device 36 and therefore downstream of the solid-state actuator 38 in the flow direction of the fluid which is flowing through the respective flow path 42 and 44 and the pump device 36, in particular the solid-state actuator 38. The valve device 94 can therefore be switched between a first switching state and a second switching state. By means of the solid-state actuator 38 and therefore by means of the pump device 36, the fluid, in particular from the reservoir, can be conveyed in precisely one conveying direction, which is illustrated in FIG. 2 by an arrow 96. If the fluid is conveyed, in particular in the conveying direction, by means of the pump device 36, i.e. by means of the solid-state actuator 38, while the valve device 94 is in the first switching state, then the fluid will be conveyed from reservoir 16 to, and into, the valve device 94 by means of the solid-state actuator 38 and is conveyed through the valve device 94, wherein, in the first switching state of the valve device 94, the fluid which is conveyed by means of the solid-state actuator 38 and thereby conveyed into the valve device 94 and conveyed through the valve device 94 is introduced into the first flow path 42 via the valve device 94, that is by means of the valve device 94, so that, in the first switching state of the valve device 94, the fluid is conveyed through the flow path 42 by means of the solid-state actuator 38 via the valve device 94. In the first switching state, however, the fluid which is conveyed by means of the solid-state actuator 38 and conveyed into the valve device 94 is prevented or disabled from flowing into and through the flow path 44 by means of the valve device 94, so that, for example, in the first switching state the flow path 42 is fluidically connected to the solid-state actuator 38 via the valve device 94 and, in the first switching state, the flow path 44 is fluidically separated from the solid-state actuator 38 by means of the valve device 94.

If the fluid, in particular from reservoir 16, is conveyed by means of the solid-state actuator 38, in particular in the conveying direction (arrow 96), while the valve device 94 is located in the second switching state, then the fluid will be conveyed to and into the valve device 94 and conveyed through the valve device 94 by means of the solid-state actuator 38, so that the fluid conveyed by means of the solid state actuator 38 and conveyed into the valve device 94 and conveyed through the valve device 94 is introduced into the second flow path 44, so that the fluid conveyed by means of the solid state actuator 38 is conveyed through the flow path 44 by means of the solid state actuator 38. In the second switching state, the valve device 94 prevents or stops the fluid conveyed by means of the solid-state actuator 38 and conveyed into the valve device 94 from flowing into and through the flow path 42. Therefore, for example in the second operating state, the flow path 44 is fluidically connected to the solid-state actuator 38 via the valve device 94 and, in the second switching state, the flow path 42 is fluidically separated from the solid-state actuator 38 by means of the valve device 94.

In the second embodiment, the solid-state actuator 38 and therefore the pump device 36, is arranged in a third flow path 98, through which the solid-state actuator 38 can convey the fluid from reservoir 16, in particular in the conveying direction. In the direction of flow of the fluid which is conveyed by the solid-state actuator 38 and flowing through the flow path 98, the flow path 98 is arranged upstream of the valve device 94. Via the flow path 98, the fluid which is conveyed by means of the solid-state actuator 38, in particular from the reservoir, is conveyed to and in particular into the valve device 94. Therefore, it is particularly conceivable that in the first switching state of the valve device 94, the flow path 42 is fluidically connected to the flow path 98 via the valve device 94, while the flow path 44 is fluidically separated from the flow path 98 by means of the valve device 94. In the second switching state, for example, the flow path 44 is fluidically connected to the flow path 98 via the valve device 94, while the flow path 42 is fluidically separated from the flow path 98 by utilizing valve device 94.

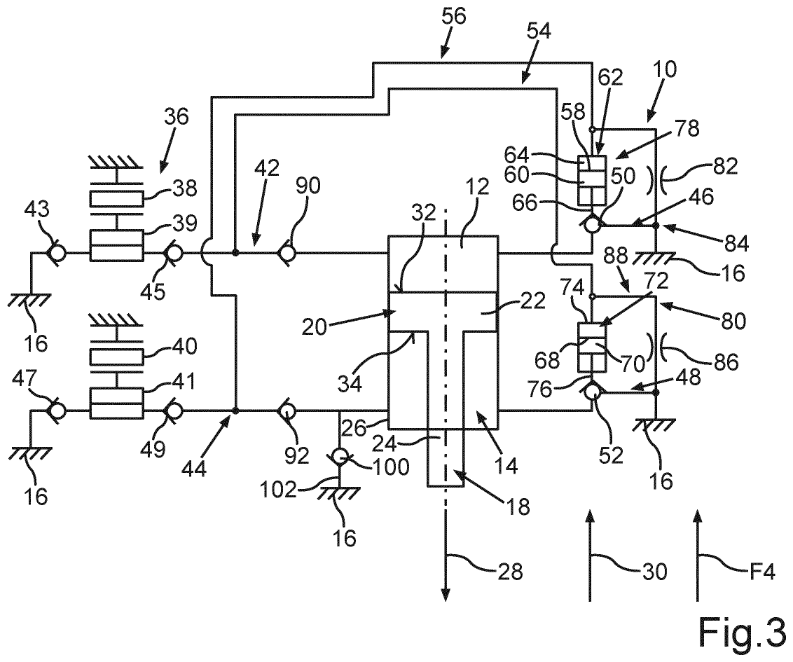

FIG. 3 indicates a schematic representation of a third embodiment of the actuator device 10. In the third embodiment, the working chamber 14 is assigned a freewheel valve 100, which is arranged in a freewheeling path 102. The freewheeling path 102 is fluidically connectable and/or connected to the working chamber 14. In addition, the freewheeling path 102 is fluidically connected to the reservoir 16 so that, as will be explained in more detail below, the freewheeling path 102 therefore bypasses the pump device 36 as well as the working chamber 12 and also the non-return and/or check valves 90 and 92 and, in the present case, also the discharge paths 46 and 48 and the valve elements 50 and 52, in particular with regard to a flow of the fluid from reservoir 16 through the freewheeling path 102 and via the freewheeling path 102 into the working chamber 14. The freewheeling valve 100 can be a non-return valve, a check valve or can be designed in the manner of a non-return valve. In the third embodiment, it is provided that the freewheeling valve 100 opens in the direction of the working chamber 14 and closes in the direction of reservoir 16. This is to be understood as meaning that the freewheeling valve 100 thereby permits a flow of the fluid from reservoir 16 via the freewheeling path 102 into the working chamber 14, the freewheeling valve 100 preventing, i.e. disables a reverse flow, i.e. a flow of the fluid from the working chamber 14 via the freewheeling path 102 into the reservoir 16. The previous and following remarks relating to the working chamber 14, in particular with regard to the freewheeling valve 102, can also be readily transferred to the working chamber 12 and vice versa.

Utilizing the freewheeling valve 100, and thereby via the freewheeling path 102, enables the fluid to be introduced from reservoir 16 into the working chamber 14 by bypassing the pump device 36 and also by bypassing the working chamber 12 and by bypassing the non-return valves 90 and 92 and by bypassing the discharge paths 46 and 48 and thereby bypassing the valve elements 50 and 52. In particular, the fluid can be introduced from reservoir 16 into the working chamber 14, to which the freewheeling valve 100 is assigned, via the freewheeling valve 100 and therefore via the freewheeling path 102, without influencing the valve elements 50 and 52 i.e. without causing a movement of the respective valve element 50 or 52 from the respective open position into the respective closed position or from the respective closed position into the respective open position. In the third embodiment illustrated in FIG. 3, the freewheeling valve 100 can therefore ensure freewheeling i.e. rapid movement of the drive unit element 20 in the second direction of movement illustrated by the arrow 30, in particular as a result of the external, fourth force (force arrow F4) acting on the drive unit element 20. As a result of the fact that, for example, the fourth force acts on the drive unit element 20, then a lower level i.e. lower pressure builds up at least temporarily or briefly in the working chamber 14 when compared to an and/or the initial level, so that fluid is conveyed, in particular sucked, from reservoir 16 into the working chamber 14 via the freewheeling path 102 and therefore via the freewheeling valve 100, in particular until pressure equalization between the working chamber 14 and reservoir 16 has occurred via the freewheeling path 102. Therefore, the drive unit element 20 can be moved particularly quickly in the second direction of movement by the fourth force until the pressure equalization between the working chamber 14 and the reservoir 16 has occurred via the freewheeling path 102. For example, in order to move the drive unit element 20 further in the second direction of movement via the freewheeling path 102 by means of the fourth force after the pressure equalization between the working chamber 14 and the reservoir 16 has occurred, as described above with regard to the fourth operating state, the fluid is conveyed from reservoir 16 via the flow path 44 into the working chamber 14 or in the direction of the working chamber 14 by means of the pump device 36, whereby the valve element 50 is actuated via the actuation path 56 and therefore opened, so that the fluid can flow out of the working chamber 12 via the discharge path 46 and, in particular, flow into reservoir 16.

Lowered pressure means that the pressure is reduced, i.e. lowered, compared to the initial level. Increased pressure means that the pressure is increased compared to the initial level.

If, for example, in or after the first or second operating state, the delivery of the fluid by means of the pump device 36 is terminated, whereby the actuation of the respective valve element 50 or 52 is terminated, then pressure equalization between the respective actuation chamber 62 or 72 in the reservoir 16 can occur and/or occurs via the respective flow-limiting element 82 or 86 and therefore, via the respective emptying path 84 or 88, in particular in such a way that the fluid can flow out of the actuating chamber 62 or 72 via the emptying path 84 or 88 and therefore via the respective flow-limiting element 82 or 86 and flow into reservoir 16. As a result, the respective valve element 50 or 52 subsequently moves back into its respective closed position. As shown in FIGS. 1 and 3, the flow-limiting element 82 or 86 can be a throttle, for example.

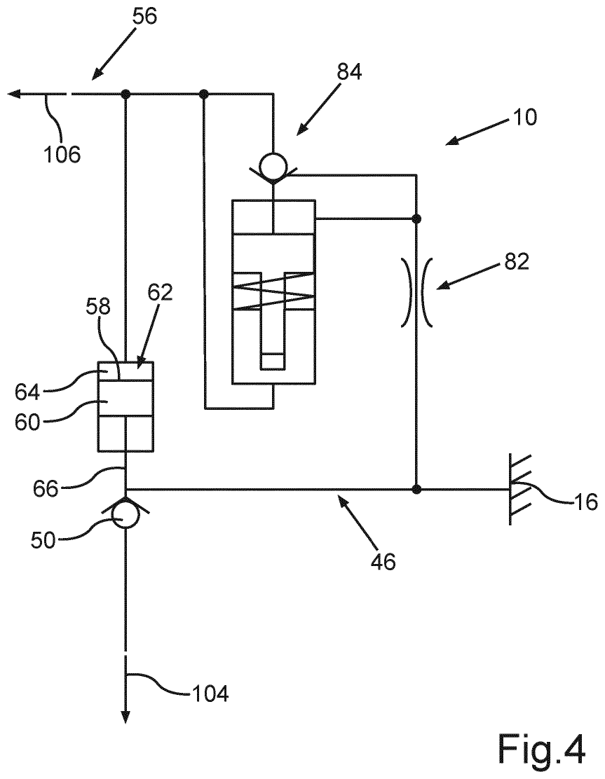

FIG. 4 shows a fourth embodiment of the actuator device 10 in a schematic representation, whereby the valve element 50 is shown as an example in FIG. 4. It is illustrated by an arrow 104 whereby, as in the first, second and third embodiments, the discharge path 46 is fluidically connectable or connected to the working chamber 12, so that the fluid can be discharged from the working chamber 12 via the discharge path 46 and directed into reservoir 16. In addition, it is hereby illustrated by an arrow 106 that the actuation path 56 is fluidically connected or connectable to the flow path 44 at the branch point A2. Also recognizable in FIG. 4 is the emptying path 84, in which the flow-limiting element 82 is arranged. However, the flow-limiting element 82 is now no longer or not only a simple throttle, but rather more a flow-controlled or flow-controlled, force-compensated switching valve, which can, in particular optionally, indicate a simple, in particular linear, throttle.

1. An actuator device comprising:
at least two working chambers which are coupled to one another in such a way that an increase in volume of a first one of the working chambers is accompanied by a reduction in volume of the second working chamber and vice versa,
a drive unit device which can be driven by the respective increase in volume of the respective working chamber and can therefore be moved,
a pump device indicating a minimum of one solid-state actuator for conveying a fluid,
an initial flow path through which the fluid conveyed by the pump device can flow and via which the fluid conveyed by the pump device and flowing through the first flow path can be introduced into the first working chamber in order to effect the increase in volume of the first working chamber,
a second flow path through which the fluid conveyed by the pump device can flow and via which the fluid conveyed by the pump device and flowing through the second flow path can be introduced into the second working chamber in order to effect the increase in volume of the second working chamber,
a first discharge path associated with the first working chamber, via which the fluid can be discharged from the first working chamber in order to reduce the volume of the first working chamber,
a second discharge path associated with the second working chamber, via which the fluid can be discharged from the second working chamber in order to reduce the volume of the second working chamber,
a first valve element arranged in the first discharge path, which can be moved between a first closed position closing the first discharge path and at least one first open position releasing the first discharge path,
a second valve element arranged in the second discharge path, which can be moved between a second closed position closing the second discharge path and at least one second open position releasing the second discharge path,
a first actuating path, which is fluidically connected to the first flow path at a first branch point arranged downstream of the pump device and upstream of the first working chamber, at which a portion of the fluid which is conveyed by means of the pump device and flowing through the first flow path can be branched off from the first flow path and subsequently introduced into the first actuating path, the second valve element can be actuated by means of the fluid introduced into the first actuation path and flowing through the first actuation path and can thereby be moved from the second closed position into the second open position, and
a second actuating path, which is fluidically connected to the second flow path at a second branching point arranged downstream of the pump device and upstream of the second working chamber, at which a portion of the fluid which is conveyed by means of the pump device and flowing through the second flow path can be branched off from the second flow path and subsequently introduced into the second actuating path, via which the first valve element can be actuated by means of the fluid introduced into the second actuating path and flowing through the second actuating path and can thereby be moved from the first closed position into the first open position.

2. The actuator device according to claim 1,
wherein the first valve element is assigned a first actuating region and a first actuating chamber which is at least partially and directly bounded by the first actuating region and into which the fluid introduced into the second actuating path and flowing through the second actuating path can be introduced,
whereby the first actuating region can be acted upon by the fluid which is introduced into the second actuating path, flowing through the second actuating path and introduced into the first actuating chamber, and
whereby the first valve element can be moved from the first closed position into the first open position.

3. The actuator device according to claim 2,
wherein a first flow-limiting element which is assigned to the first actuating region and the first actuating chamber and which is connected parallel to the first actuating chamber and the first actuating region in the flow direction of the fluid, thereby flowing through the second actuating path and flowing into the first actuating chamber, and
wherein the fluid can be subsequently discharged from the first actuating chamber via the first flow-limiting element in order therefore to cause and/or permit a movement of the first valve element from the first open position into the first closed position.

4. The actuator device according to claim 1,
wherein the second valve element is assigned a second actuating region and a second actuating chamber which is at least partially and directly bounded by the second actuating region and into which the fluid which is introduced into the first actuating path and flowing through the first actuating path can be introduced,
whereby the second actuating region can be acted upon by the fluid which is introduced into the first actuating path, therefore flowing through the first actuating path and introduced into the second actuating chamber, and
whereby the second valve element can be moved from the second closed position into the second open position.

5. The actuator device according to claim 4,
wherein a second flow-limiting element which is assigned to the second actuating region and the second actuating chamber and which is connected parallel to the second actuating chamber and the second actuating region in the flow direction of the fluid flowing through the first actuating path and thereby flowing into the second actuating chamber, and
wherein the fluid can be subsequently discharged from the second actuating chamber via the second flow limiting element in order to thereby cause and/or permit a movement of the second valve element from the second open position into the second closed position.

6. The actuator device according to claim 1, wherein a first non-return valve is arranged in the first flow path downstream of the first branch point and upstream of the first working chamber, which prevents a flow of the fluid through the first flow path in the direction of the first branch point and enables it in the direction of the first working chamber.

7. The actuator device according to claim 6,
wherein a second non-return or check valve is arranged in the second flow path downstream of the second branch point and upstream of the second working chamber, and
whereby the non-return valve prevents a flow of the fluid through the second flow path in the direction of the second branch point and permits it in the direction of the second working chamber.

8. The actuator device according to claim 1, wherein the pump device indicates:
the solid-state actuator assigned to the first flow path as a first solid-state actuator for conveying the fluid through the first flow path, and
a second solid-state actuator assigned to the second flow path for pumping the fluid through the second flow path.

9. The actuator device according to claim 1, wherein the pump device comprises:
the solid-state actuator as a solid-state actuator common to the first flow path and the second flow path for conveying the fluid, and
a valve device which is switchable between:
a first switching state in which:
the fluid conveyed by means of the solid-state actuator can be introduced into the first flow path via the valve device and can be conveyed through the first flow path, and
by utilizing the valve device, an introduction of the fluid conveyed by means of the solid-state actuator via the valve device into the second flow path is prevented, and
a second switching state, in which:
the fluid conveyed by means of the solid-state actuator can be introduced into the second flow path via the valve device and can be conveyed through the second flow path, and
the valve device prevents the fluid conveyed by the solid-state actuator from being introduced into the first flow path via the valve device.

10. The actuator device according to claim 9, wherein the solid-state actuator is arranged in a third flow path and is arranged upstream of the valve device, via which the fluid conveyed by means of the solid-state actuator through the third flow path is to be guided to the valve device.

11. The actuator device according to claim 1, wherein the drive unit device indicates a drive unit element which partially and directly bounds the working chambers in each case and which:
is movably accommodated in a housing as partially delimiting the working chambers,
by introducing the fluid into the first working chamber, can be acted upon directly by the fluid which is introduced into the first working chamber and can thereby be moved in a first direction of movement relative to the housing, and
can be acted upon directly by the fluid which is introduced into the second working chamber by introducing the fluid into the second working chamber and can thereby be moved relative to the housing in a second direction of movement opposite to the first direction of movement.

12. The actuator device according to claim 11, wherein the drive unit element can be moved translationally and/or rotationally and/or oscillatingly in the respective direction of movement relative to the housing.

13. The actuator device according to claim 1, wherein a freewheeling valve is assigned to one of the working chambers, via which the fluid can be introduced from a reservoir into the one working chamber, bypassing the pump device, the freewheeling valve opening in the direction of the one working chamber and closing in the direction of the reservoir.

14. A method for operating an actuator device, in which the actuator device indicates:
a minimum of two working chambers which are coupled to one another in such a way that an increase in volume of a first of the working chambers is accompanied by a reduction in volume of the second working chamber and vice versa,
a drive unit device, which is driven by the respective increase in volume of the respective working chamber and moved thereby,
a pump device indicating a minimum of one solid actuator, by means of which a fluid is conveyed,
a first flow path through which the fluid conveyed by the pump device can flow, via which the fluid conveyed by the pump device and flowing through the first flow path is introduced into the first working chamber in order to effect the increase in volume of the first working chamber,
a second flow path through which the fluid conveyed by the pump device can flow, via which the fluid conveyed by the pump device and flowing through the second flow path is introduced into the second working chamber in order to effect the increase in volume of the second working chamber,
a first discharge path associated with the first working chamber, via which the fluid is discharged from the first working chamber to reduce the volume of the first working chamber,
a second discharge path associated with the second working chamber, via which the fluid is discharged from the second working chamber to reduce the volume of the second working chamber,
a first valve element arranged in the first discharge path, which is moved between a first closed position closing the first discharge path and a minimum of one first open position releasing the first discharge path,
a second valve element arranged in the second discharge path, which is moved between a second closed position closing the second discharge path and a minimum of one second open position releasing the second discharge path,
a first actuating path, which is fluidically connected to the first flow path at a first branching point arranged downstream of the pump device and upstream of the first working chamber, at which a portion of the fluid which is conveyed by means of the pump device and flowing through the first flow path is subsequently branched off from the first flow path and introduced into the first actuating path, via which the second valve element is actuated by means of the fluid which is introduced into the first actuating path and flowing through the first actuating path and is thereby moved from the second closed position into the second open position, and
a second actuating path, which is fluidically connected to the second flow path at a second branch point arranged downstream of the pump device and upstream of the second working chamber, at which a portion of the fluid which is conveyed by means of the pump device and flowing through the second flow path is subsequently branched off from the second flow path and introduced into the second actuating path, via which the first valve element is actuated by means of the fluid introduced into the second actuating path and flowing through the second actuating path and is thereby moved from the first closed position into the first open position.
